(19) United States
(12) Patent Application Publication
(10) Pub. No.: US 2025/0343931 A1
(43) Pub. Date: Nov. 6, 2025

(54) JOINTLY CODING OF TEXTURE AND DISPLACEMENT DATA IN DYNAMIC MESH CODING

(71) Applicants: Douyin Vision Co., Ltd., Beijing (CN); Bytedance Inc., Los Angeles, CA (US)

(72) Inventors: Jizheng Xu, San Diego, CA (US); Danying Wang, Beijing (CN)

(21) Appl. No.: 19/265,155

(22) Filed: Jul. 10, 2025

Related U.S. Application Data
(63) Continuation of application No. PCT/CN2024/071941, filed on Jan. 12, 2024.

(30) Foreign Application Priority Data
Jan. 12, 2023 (WO) PCT/CN2023/071918
Apr. 20, 2023 (WO) PCT/CN2023/089469

(51) Int. Cl. H04N 19/25; H04N 19/174; H04N 19/184

(52) U.S. Cl. CPC H04N 19/25; H04N 19/174; H04N 19/184

(57) ABSTRACT

A mechanism for processing video data is disclosed. The mechanism includes determining that the texture data and the displacement data are included in a single bitstream and use different coding methods. A conversion is performed between the visual media data and the single bitstream based on the different coding methods of the texture data and the displacement data.

### CROSS-REFERENCE TO RELATED APPLICATIONS

This patent application is a continuation of International Patent Application No. PCT/CN2024/071941, filed on Jan. 12, 2024, which claims the benefit of International Patent Application No. PCT/CN2023/089469, filed on Apr. 20, 2023, and International Patent Application No. PCT/CN2023/071918, filed on Jan. 12, 2023. All the aforementioned patent applications are hereby incorporated by reference in their entireties.

### TECHNICAL FIELD

This present disclosure relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video media data including texture data and displacement data, comprising: determining that the texture data and the displacement data are included in a single bitstream and use different coding methods; and performing a conversion between the visual media data and the single bitstream based on the different coding methods of the texture data and the displacement data.

Optionally, in any of the preceding aspects, another implementation of the aspect provides that the different coding methods comprise a first quantization parameter and a second quantization parameter different from the first quantization parameter, and wherein the texture data uses the first quantization parameter and the displacement data uses the second quantization parameter.

Optionally, in any of the preceding aspects, another implementation of the aspect provides that the different coding methods comprise lossless coding, and wherein all video units of the displacement data use the lossless coding.

Optionally, in any of the preceding aspects, another implementation of the aspect provides that the different coding methods comprise a transquant bypass mode from the high efficiency video coding (HEVC) standard, and wherein all video units of the displacement data use the transquant bypass mode.

Optionally, in any of the preceding aspects, another implementation of the aspect provides that the different coding methods comprise a transform skip mode and a quantization parameter, and wherein all video units of the displacement data use the transform skip mode and the quantization parameter.

Optionally, in any of the preceding aspects, another implementation of the aspect provides that the quantization parameter is equal to 4+6*K, where K is an integer.

Optionally, in any of the preceding aspects, another implementation of the aspect provides that K has a value of zero.

Optionally, in any of the preceding aspects, another implementation of the aspect provides padding a picture in the single bitstream using data other than the texture data and the displacement data.

Optionally, in any of the preceding aspects, another implementation of the aspect provides that the picture is padded with a fixed value.

Optionally, in any of the preceding aspects, another implementation of the aspect provides that the picture is padded with a middle pixel value, and wherein the middle pixel value is 128 for an 8-bit video or 512 for a 10-bit video.

Optionally, in any of the preceding aspects, another implementation of the aspect provides that the picture is padded with a value of a nearest pixel in the texture data or with a value of a nearest pixel in the displacement data.

Optionally, in any of the preceding aspects, another implementation of the aspect provides inserting N rows of luma samples and N/2 rows of chroma samples between the texture data and the displacement data when the picture is padded, where N is an integer.

Optionally, in any of the preceding aspects, another implementation of the aspect provides that a value of N is 16.

Optionally, in any of the preceding aspects, another implementation of the aspect provides that a value of N is 0.

Optionally, in any of the preceding aspects, another implementation of the aspect provides that all samples in the N rows of luma samples and the N/2 rows of chroma samples have a same value.

Optionally, in any of the preceding aspects, another implementation of the aspect provides that the same value comprises a middle pixel value.

Optionally, in any of the preceding aspects, another implementation of the aspect provides converting the displacement data to a 4:2:0 format, and concatenating the displacement data as converted with the texture data in the 4:2:0 format.

Optionally, in any of the preceding aspects, another implementation of the aspect provides converting the displacement data to N-bit, wherein the N-bit is a bitdepth of the texture data, and where N is an integer.

Optionally, in any of the preceding aspects, another implementation of the aspect provides that N is 10.

Optionally, in any of the preceding aspects, another implementation of the aspect provides that the texture data and the displacement data are coded in different slices.

Optionally, in any of the preceding aspects, another implementation of the aspect provides that one or more of a position and a size of the texture data are included in the single bitstream.

Optionally, in any of the preceding aspects, another implementation of the aspect provides that one or more of a position and a size of the displacement data are included in the single bitstream.

Optionally, in any of the preceding aspects, another implementation of the aspect provides that one or more of a position and a size of the texture data are inferred based on information in the single bitstream.

Optionally, in any of the preceding aspects, another implementation of the aspect provides that one or more of a position and a size of the displacement data are inferred based on information in the single bitstream.

Optionally, in any of the preceding aspects, another implementation of the aspect provides applying a smoothing process to a picture in the single bitstream.

Optionally, in any of the preceding aspects, another implementation of the aspect provides that only a padded area of the picture is smoothed by the smoothing process.

Optionally, in any of the preceding aspects, another implementation of the aspect provides that the displacement data is coded in 4:2:0 format.

Optionally, in any of the preceding aspects, another implementation of the aspect provides that the displacement data is converted to the 4:2:0 format prior to encoding, and converted to a 4:4:4 format after decoding.

Optionally, in any of the preceding aspects, another implementation of the aspect provides that one or more of an sps_chroma_format_idc syntax element and a ChromaFormatIdc variable is set to 1 for coding the displacement data.

Optionally, in any of the preceding aspects, another implementation of the aspect provides that coding of the displacement data uses a main profile or a main10 profile.

Optionally, in any of the preceding aspects, another implementation of the aspect provides that the displacement data is packed into luma components and chroma components in the 4:2:0 format when the displacement data has only one non-zero component.

Optionally, in any of the preceding aspects, another implementation of the aspect provides determining, at a decoder, whether the displacement data has only one non-zero component or has three non-zero components.

Optionally, in any of the preceding aspects, another implementation of the aspect provides determining, at a decoder, whether the displacement data has only one non-zero component or has three non-zero components based on a video resolution of the displacement data and a number of base mesh points.

Optionally, in any of the preceding aspects, another implementation of the aspect provides determining, at a decoder, whether the displacement data has only one non-zero component or has three non-zero components based on a video resolution of the displacement data and a number of vertexes.

Optionally, in any of the preceding aspects, another implementation of the aspect provides that the conversion includes encoding the media data into a bitstream.

Optionally, in any of the preceding aspects, another implementation of the aspect provides that the conversion includes decoding the media data from a bitstream.

A second aspect relates to an apparatus for processing media data comprising: a processor; and a non-transitory memory with instructions thereon, wherein the instructions upon execution by the processor, cause the processor to perform the method of any of the disclosed embodiments.

A third aspect relates to a non-transitory computer readable medium, comprising a computer program product for use by a video coding device, the computer program product comprising computer executable instructions stored on the non-transitory computer readable medium such that when executed by a processor cause the video coding device to perform the method of any of the disclosed embodiments.

A fourth aspect relates to a non-transitory computer-readable recording medium storing a bitstream of a video which is generated by a method performed by a video processing apparatus, wherein the method comprises the method of any of the disclosed embodiments.

A fifth aspect relates to a method for storing a bitstream of a video comprising the method of any of the disclosed embodiments.

A sixth aspect relates to a method, apparatus, or system described in the present disclosure.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example decoder design for dynamic mesh coding.

FIG. 2 illustrates an example structure of a dynamic mesh coding test model.

FIG. 3 illustrates an example combination of texture and displacement data into one picture.

FIG. 4 illustrates another example combination of texture and displacement data into one picture.

FIG. 5 is a block diagram showing an example video processing system.

FIG. 6 is a block diagram of an example video processing apparatus.

FIG. 7 is a flowchart for an example method of video processing.

FIG. 8 is a block diagram that illustrates an example video coding system.

FIG. 9 is a block diagram that illustrates an example encoder.

FIG. 10 is a block diagram that illustrates an example decoder.

FIG. 11 is a schematic diagram of an example encoder.

FIG. 12 is a flowchart for an example method of video processing.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Section headings are used in the present disclosure for ease of understanding and do not limit the applicability of techniques and embodiments disclosed in each section only to that section. Furthermore, the techniques described herein are applicable to other video codec protocols and designs.

### 1. Initial Discussion

This disclosure is related to Moving Picture Experts Group (MPEG)-I video-based dynamic mesh coding. Specifically, it is related to how to jointly code the displacement and texture data. It may be also applicable to other immersive video coding standards or codecs.

### 2. Further Discussion

In computer graphics, a three dimensional (3D)/immersive content can usually be represented by a 3D mesh and a texture map. Those mesh and texture data can be generated by a machine or can be converted from images captured by multiple cameras from different angles. Similar to two dimensional (2D) video, when those 3D contents change with time, the mesh and texture data also change and consist a sequence of dynamic mesh. The data volume of dynamic mesh are usually huge and make it difficult to store and transmit. To meet the requirement of applications that use dynamic mesh, MPEG issued a call for proposal. To efficiently use the 2D codecs, one of the requirements is to use a 2D video coding standard to compress most data and keep other parts simple and of low complexity. Such a requirement can guarantee that the representation can take advantages of the 2D video hardware/software systems, without much efforts to redesign a specific system just for dynamic mesh.

MPEG received several responses to the call for proposal. Among them, one scheme showed better performance compared with others. A test model was built for the development of the planned dynamic mesh coding standard.

A test model of dynamic mesh coding can be found via this link http://mpegx.int-evry.fr/software/MPEG/dmc/mpeg-vmesh-tm/-/tags/v2.0; and the latest working draft document is working draft (WD) 1.0.

### 2.1 Data Representation in Dynamic Mesh Coding

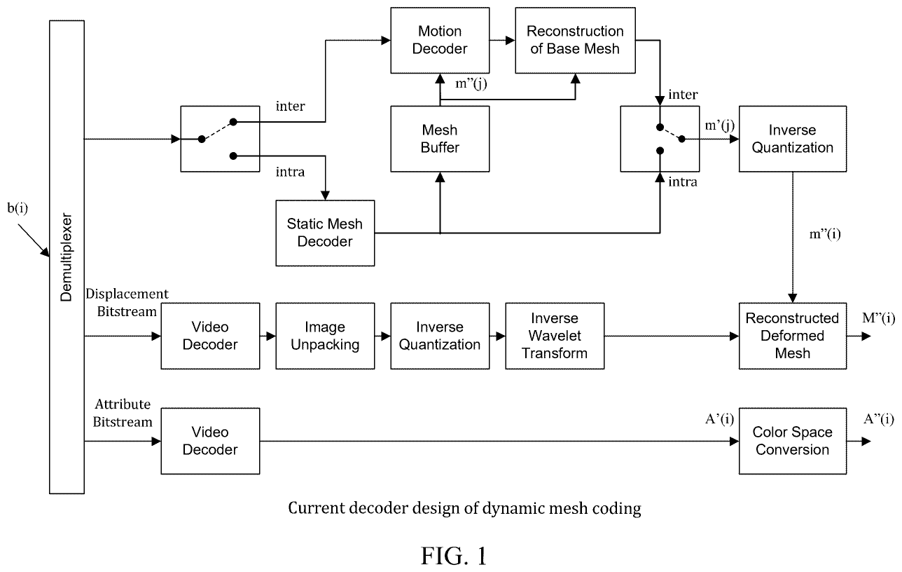

FIG. 1 illustrates an example decoder design for dynamic mesh coding. FIG. 1 shows am example decoder design. It can be seen that a dynamic mesh decoder receives three bitstreams and performs decoding to reconstruct the dynamic mesh plus texture signals. The first bitstream is to represent the base mesh, a decimated version of the original mesh. The second bitstream is to represent displacement vectors between the reconstructed base mesh and the original mesh. The displacement vectors are arranged as a 2D video and compressed with an 2D video coding standard compliant codec. The third bitstream is to represent the texture (or attribute map). The attribute map is also arranged as a 2D video and compressed with an 2D video coding standard compliant codec. The design philosophy is to make the base mesh part small enough so that the module to process base mesh can be implemented simply. On the other hand, the displacement vectors and the attribute map accounts for most of the volume of the whole dynamic mesh data, which can be processed with dedicated high efficient 2D video coding systems. Such a design can reduce the extra efforts to implement the dynamic mesh coding system and guarantee the high throughout and coding efficiency for the dynamic mesh data.

### 2.2 Test Model of Dynamic Mesh Coding

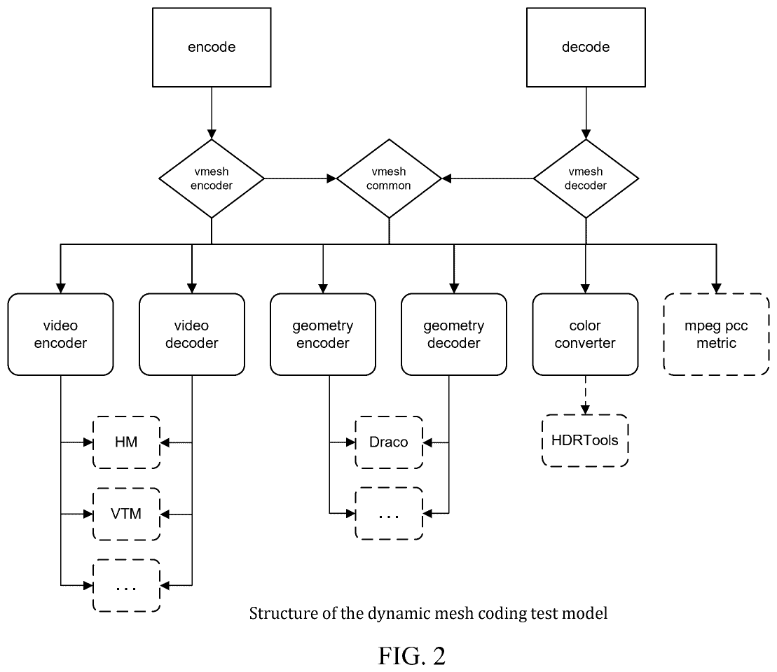

FIG. 2 illustrates an example structure of a dynamic mesh coding test model. FIG. 2 shows the structure of an example dynamic mesh coding model. In this model, Draco is used to compress base mesh and the high efficiency video coding (HEVC) test model (HM) is used to compress displacement vectors and attribute map. However, it should be noted that other mesh or video coding systems can also be used in dynamic mesh coding.

The base mesh m is generated from the original mesh with a down-sampling scheme. Its quantized version m′ is then coded using Draco. The reconstrused base mesh m″ can be obtained by inverse quantization of m′. Displacement vectors d′ are generated by making the difference between the original mesh and the subdivided version of m″ using a subdivision scheme.

### 2.3 Coding of Displacement Vectors

After obtaining displacement vectors d′, the difference between the original mesh and the subdivied base mesh, a lifting-based wavelet transform is applied to further make the energy compact. Then the wavelet transform coefficients are traversed from low to high frequency using a Morton order to form 2D coefficient blocks. Various 2D coefficient blocks comprise a picture to be processed by a 2D codec.

### 2.4 Motion Field Coding

In an example test model, motion fields between base meshes are directly coded using arithmetic coding. An example design investigates coding of motion fields also with a standard compliant 2D coding system and showed that the coding efficiency loss is marginal. Thus, it may make sense to further shift the coding process of motion field to a 2D video codec.

### 2.2 Chroma Formats

In H.264/advanced video coding (AVC), H.265/HEVC and H.266/versatile video coding (VVC), different chroma formats are supported. The format may be signalled by the syntax element sps_chroma_format_idc and represented by the variable ChromaFormatIdc. The following table illustrates the chroma formats corresponding to different sps_chroma_format_idc:

| sps_chroma_format_idc | Chroma format |
|---|---|
| 0 | Monochrome |
| 1 | 4:2:0 |
| 2 | 4:2:2 |
| 3 | 4:4:4 |

### 2.7 Example Designs

In an example design, ideas are presented to combine multiple attributes, including texture, displacement data, occupancy data into one video for encoding/decoding without requiring multiple encoding/decoding capabilities on a device. This disclosure describes details on how texture and displacement data are jointly coded for dynamic mesh coding.

### 3. Technical Problems Solved by Disclosed Technical Solutions

In an example design of dynamic mesh coding, there are the following problems:

First, texture and displacement data are coded into two separate bitstreams, which needs two encoders or decoders to support the implementation. A single bitstream thus is more preferred.

Second, displacement data are coded in 4:4:4 or 4:0:0 format, which needs more encoding/decoding resources in HEVC.

### 4. A Listing of Solutions and Embodiments

The detailed list below should be considered as examples to explain general concepts. These examples should not be interpreted in a narrow way. Furthermore, these examples can be combined in any manner.
1. To solve problem 1, texture and displacement data are combined into one video for encoding/decoding.
   a. In one example, displacement data may be converted to 4:2:0 format and concatenated with texture in 4:2:0 format.
   b. In one example, displacement data may be converted to N-bit that is the bitdepth of the texture.
      i. In one example, N is 10.
   c. In one example, texture and displacement data are coded in different slices.
   d. In one example, the positions and/or sizes of the texture area and/or the displacement data area may be signalled in the bitstream.
   e. In one example, the positions and/or sizes of the texture area and/or the displacement data area may be inferred from the bitstream.
2. To better solve problem 1, texture part and displacement part coded in one video may use different encoding strategies/methods.
   a. In one example, texture may use one quantization parameter (QP) and displacement data may use a different QP.
   b. In one example, all video units of displacement data use lossless coding.
      i. In one example, all video units of displacement data apply transquant_bypass mode in HEVC.
      ii. In one example, all video units of displacement data apply transform skip mode and QP equal to 4+6*K.
         1. In one example, K is 0.
3. To better solve problem 1, an encoder may pad data to area in the combined picture but not belongs to either texture or displacement data.
   a. In one example, the area is padded with a fixed value
      i. In one example, the area is padded with the middle pixel value, i.e., 1<< (bitdepth−1), for example, 128 for 8-bit video and 512 for 10-bit video.
   b. In one example, the area is padded with the value of the nearest pixel either in texture area or displacement data area.
   c. In one example, N rows of luma samples and N/2 rows of chroma samples are inserted between texture and displacement data.
      i. In one example, N is 16.
      ii. In one example, N is 0.
      iii. In one example, all inserted samples have the same value, e.g. middle pixel value.
4. To better solve problem 1, a smoothing process may be applied to the combined picture.
   a. In one example, only the padded area may be smoothed.
5. To solve problem 2, displacement data may be coded in 4:2:0 format.
   a. In one example, displacement data may be converted to 4:2:0 before encoding and converted back to 4:4:4 after decoding.
   b. In one example, sps_chroma_format_idc and/or ChromaFormatIdc may be set to 1 for displacement data coding.
   c. In one example, in HEVC, coding of displacement data may use main or main10 profile.
   d. In one example, when displacement data have only one non-zero component, the displacement data may be packed into luma and chroma components in 4:2:0 format.
6. To better solve problem 2, whether displacement data have only one non-zero component or three non-zero components may be derived at the decoder.
   a. In one example, based on the displacement video resolution and number of base mesh points, whether displacement data have only one non-zero component or three non-zero components may be derived at the decoder.
   b. In one example, based on the displacement video resolution and number of vertexes, whether displacement data have only one non-zero component or three non-zero components may be derived at the decoder.

### 5. Embodiments

### 5.1. Embodiment 1

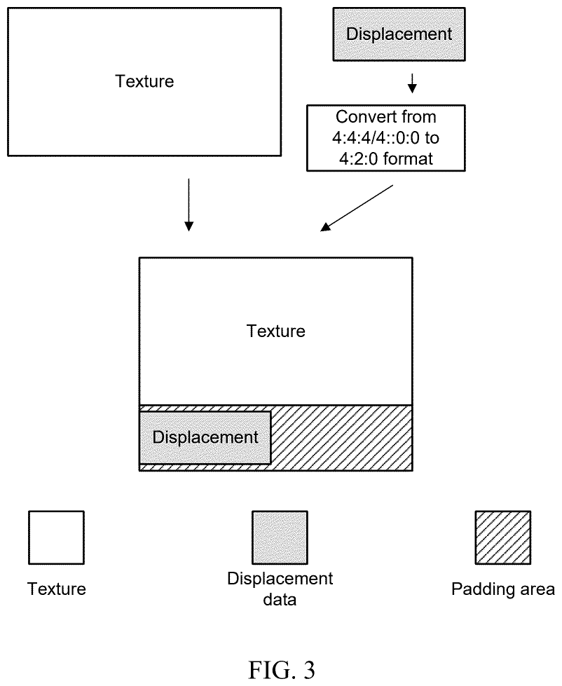

FIG. 3 illustrates an example combination of texture and displacement data into one picture. Assume that the size of texture is WT×HT and the size of displacement data is WD×HD in luma sample unit. FIG. 3 shows one exemplary combination of texture and displacement data. The texture is placed from (0, 0) to (WT−1, HT−1) in the combined picture. The displacement will be placed from (0, floor (HT/N)*N) to (WD, floor (HT/N)*N+HT−1) after being converted to 4:2:0 format, N is the length of the minimum coding unit. The picture has the minimal size to cover both the texture and the displacement data and can be processed directly by a standard compliant coding system. A new slice begins from the upper-left corner of the displacement data region in the combined picture. All the others are of padding area, in which an encoder pad data according some methods.

### 5.2. Embodiment 2

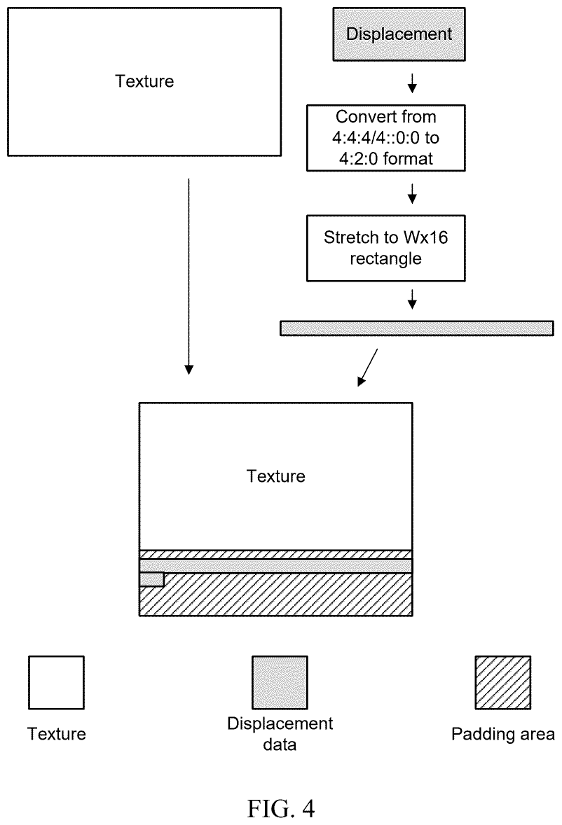

FIG. 4 illustrates another example combination of texture and displacement data into one picture. Assume that the size of texture is WT×HT and the size of displacement data is WD×HD in luma sample unit. The following figure shows another exemplary combination of texture and displacement data. The texture is placed from (0, 0) to (WT−1, HT−1) in the combined picture. The displacement data are firstly converted to 4:2:0 format and then stretched into rectangular area with height being H, where H is the length of the basic displacement block (currently H is equal to 16 in luma sample unit). The stretched displacement data will be placed starting from (0, floor (HT/N)*N) coding unit (usually the value is 8), top to bottom, left to right. The picture has the minimal size to cover both the texture and the displacement data and can be processed directly by a standard compliant coding system. All the others are of padding area, in which an encoder pad data according some methods.

### 6. References

[1] MPEG technical requirements, “CfP for. Dynamic Mesh Coding,” ISO/IEC JTC 1/SC 29/WG 2 doc. no. N145, in October 2021.
[2] K. Mammou, J. Kim, A. Tourapis and D. Podborski, “[V-CG] Apple's Dynamic Mesh Coding CfP Response,” ISO/IEC JTC 1/SC 29/WG 7 doc. no. m59281, in April 2022.
[3] MPEG output document, “WD 1.0 of V-DMC,” ISO/IEC JTC 1/SC 29/WG 7 doc. no. N0486, in November 2022.
[4] C. Huang, X. Xu, X. Zhang, J. Tian and S. Liu, “Investigation of video coding of motion fields,” ISO/IEC JTC 1/SC 29/WG 7 doc. no. m61005, in July 2022.

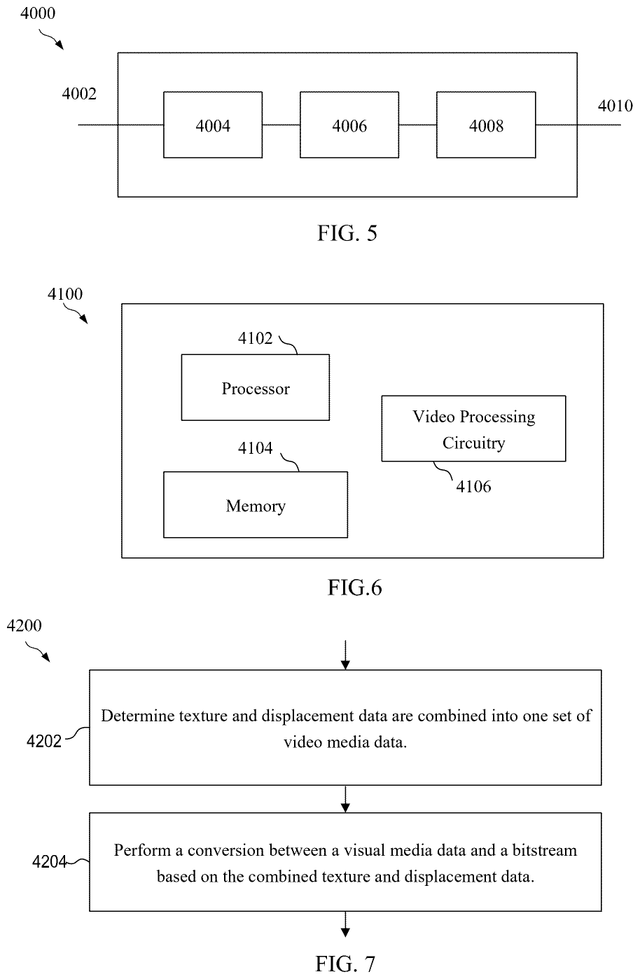

FIG. 5 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8 or 10 bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as wireless fidelity (Wi-Fi) or cellular interfaces.

The system 4000 may include a coding component 4004 that may implement the various coding or encoding methods described in the present disclosure. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include serial advanced technology attachment (SATA), peripheral component interconnect (PCI), integrated drive electronics (IDE) interface, and the like. The techniques described in the present disclosure may be embodied in various electronic devices such as mobile phones, laptops, smartphones or other devices that are capable of performing digital data processing and/or video display.

FIG. 6 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present disclosure. The memory (memories) 4104 may be used for storing data and code used for implementing the methods and techniques described herein. The video processing circuitry 4106 may be used to implement, in hardware circuitry, some techniques described in the present disclosure. In some embodiments, the video processing circuitry 4106 may be at least partly included in the processor 4102, e.g., a graphics co-processor.

FIG. 7 is a flowchart for an example method 4200 of video processing. The method 4200 includes determining texture and displacement data are combined into one set of video media data at step 4202. A conversion is performed between a visual media data and a bitstream based on the combined texture and displacement data at step 4204. The conversion of step 4204 may include encoding at an encoder or decoding at a decoder, depending on the example.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

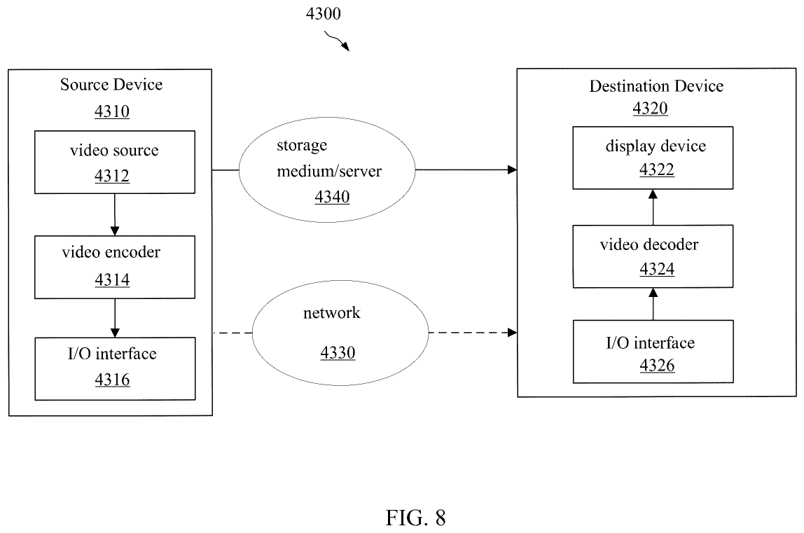

FIG. 8 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

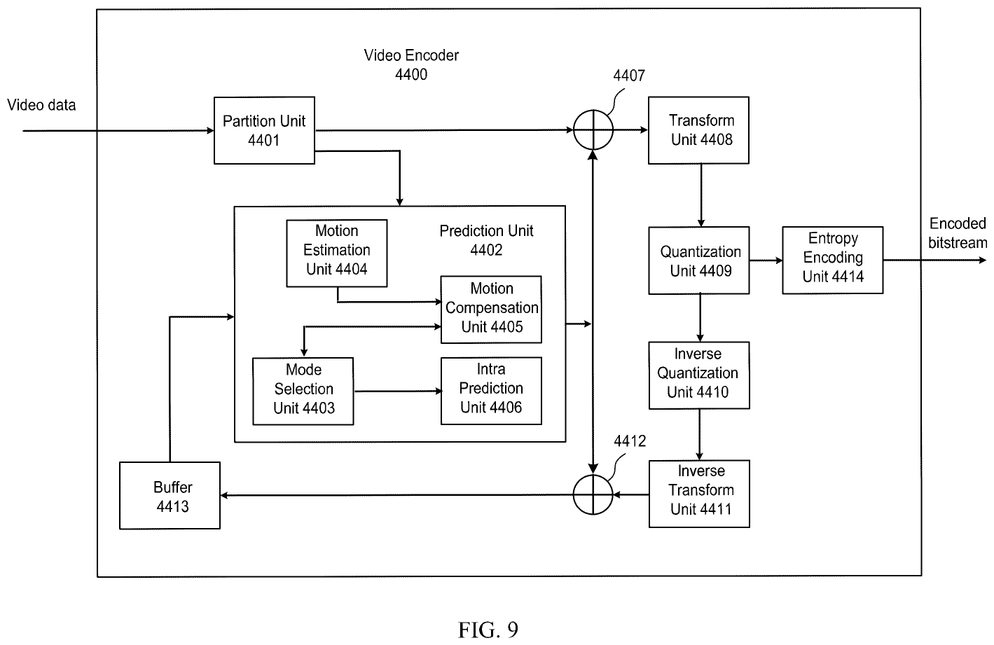

FIG. 9 is a block diagram illustrating an example of video encoder 4400, which may be video encoder 4314 in the system 4300 illustrated in FIG. 8. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401, a prediction unit 4402 which may include a mode select unit 4403, a motion estimation unit 4404, a motion compensation unit 4405, an intra prediction unit 4406, a residual generation unit 4407, a transform processing unit 4408, a quantization unit 4409, an inverse quantization unit 4410, an inverse transform unit 4411, a reconstruction unit 4412, a buffer 4413, and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

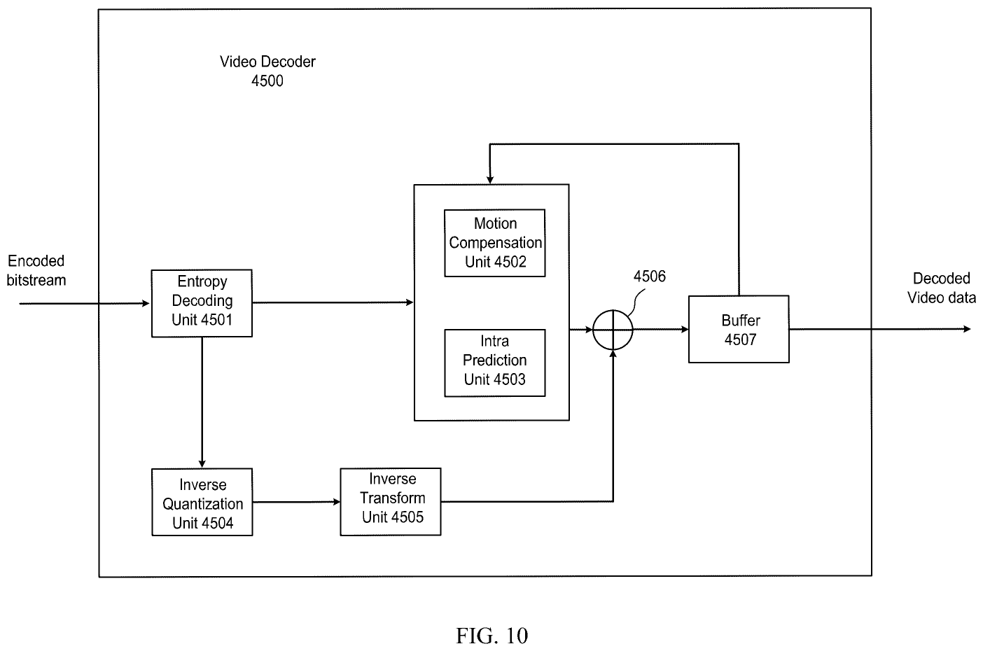

FIG. 10 is a block diagram illustrating an example of video decoder 4500 which may be video decoder 4324 in the system 4300 illustrated in FIG. 8. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

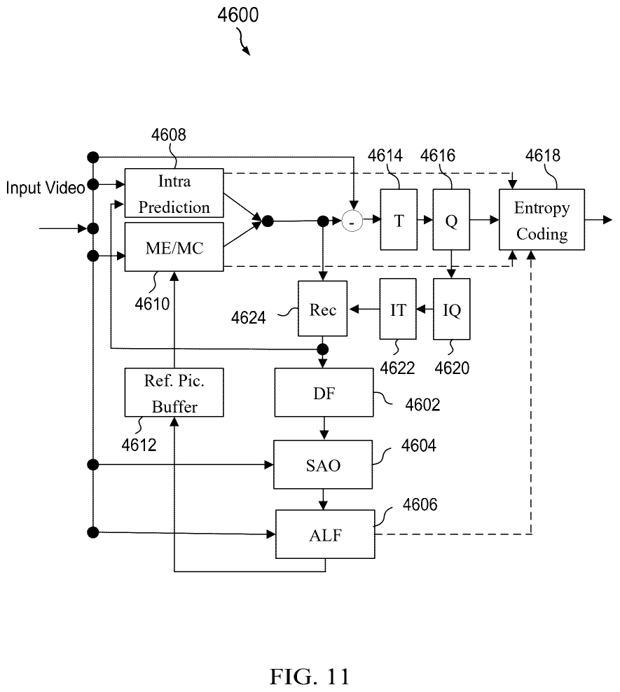

FIG. 11 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

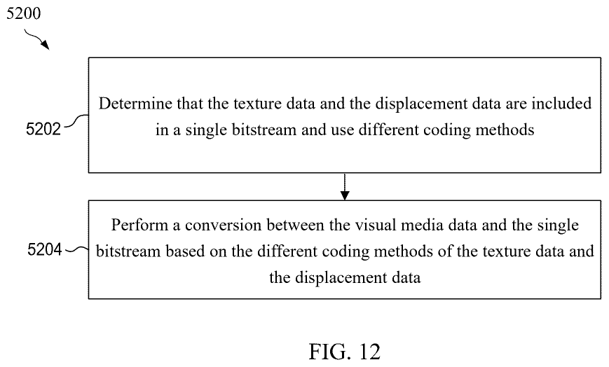

FIG. 12 is a flowchart 5200 for an example method of video processing. In an embodiment, the method is performed by an encoder (e.g., encoding device) or by a decoder (e.g., a decoding device). In block 5202, the method includes determining that the texture data and the displacement data are included in a single bitstream and use different coding methods (e.g., a different quantization parameter, lossless coding, transquant bypass mode from the high efficiency video coding (HEVC) standard, etc.). In block 5204, the method includes performing a conversion between the visual media data and the single bitstream based on the different coding methods of the texture data and the displacement data. The conversion of step 5204 may include encoding at an encoder or decoding at a decoder, depending on the example.

A listing of solutions preferred by some examples is provided next.

The following solutions show examples of techniques discussed herein.
1. A method for processing video data comprising: determining texture and displacement data are combined into one set of video media data; and performing a conversion between the visual media data and a bitstream based on the combined texture and displacement data.
2. The method of solution 1, wherein the displacement data is converted to 4:2:0 format and concatenated with the texture in 4:2:0 format.
3. The method of any of solutions 1-2, wherein the displacement data is converted to an N-bit bitdepth that is equal to a bitdepth of the texture.
4. The method of any of solutions 1-3, wherein the N-bit bitdepth is a bit depth of 10.
5. The method of any of solutions 1-4, wherein texture and displacement data are coded in different slices.
6. The method of any of solutions 1-5, wherein positions of a texture area, sizes of the texture area, or a displacement data area are signalled in the bitstream.
7. The method of any of solutions 1-6, wherein positions of a texture area, sizes of the texture area, or a displacement data area are inferred from the bitstream.
8. The method of any of solutions 1-7, wherein the texture and displacement data are coded using different coding mechanisms.
9. The method of any of solutions 1-8, wherein the texture and displacement data are coded using different quantization parameters (QPs).
10. The method of any of solutions 1-9, wherein the displacement data are coded using lossless coding.
11. The method of any of solutions 1-10, wherein the displacement data are coded using transquant_bypass mode.
12. The method of any of solutions 1-11, wherein the displacement data are coded using transform skip mode and QP equal to 4+6*K, wherein k is equal to zero.
13. The method of any of solutions 1-12, wherein an area of a picture including the texture and displacement data is padded.
14. The method of any of solutions 1-13, wherein the area is padded with a fixed value.
15. The method of any of solutions 1-14, wherein the area is padded with a middle pixel value.
16. The method of any of solutions 1-15, wherein the area is padded with a nearest pixel value.
17. The method of any of solutions 1-16, wherein a smoothing process is applied to the picture including the texture and displacement data.
18. The method of any of solutions 1-17, wherein the smoothing process is applied only to a padded area in the picture including the texture and displacement data.
19. The method of any of solutions 1-18, wherein displacement data is coded in 4:2:0 format.
20. The method of any of solutions 1-19, wherein the displacement data is converted from 4:4:4 to 4:2:0 when the conversion includes encoding, and wherein the displacement data is converted from back 4:2:0 to 4:4:4 when the conversion includes decoding.
21. The method of any of solutions 1-20, wherein sps_chroma_format_idc or ChromaFormatIdc are set to 1 for displacement data coding.
22. The method of any of solutions 1-21, wherein displacement data is coded using a main or main10 profile.
23. An apparatus for processing video data comprising: a processor; and a non-transitory memory with instructions thereon, wherein the instructions upon execution by the processor, cause the processor to perform the method of any of solutions 1-22.
24. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-22.
25. A non-transitory computer-readable recording medium storing a bitstream of a video which is generated by a method performed by a video processing apparatus, wherein the method comprises: determining texture and displacement data are combined into one set of video media data; and generating the bitstream based on the determining.
26. A method for storing bitstream of a video comprising: determining texture and displacement data are combined into one set of video media data; generating the bitstream based on the determining; and storing the bitstream in a non-transitory computer-readable recording medium.
27. A method, apparatus, or system described in the present disclosure.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present disclosure, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this disclosure can be implemented in digital electronic circuitry, or in computer software, firmware, or hardware, including the structures disclosed in this disclosure and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., a field programmable gate array (FPGA) or an application specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While this present disclosure contains many specifics, these should not be construed as limitations on the scope of any subject matter or of what may be claimed, but rather as descriptions of features that may be specific to particular embodiments of particular techniques. Certain features that are described in this present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this present disclosure should not be understood as requiring such separation in all embodiments.

Only a few implementations and examples are described and other implementations, enhancements and variations can be made based on what is described and illustrated in this present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing visual media data including texture data and displacement data, comprising:
coding the texture data and the displacement data in a single bitstream or a single video during a conversion between the single video and the single bitstream; and
performing the conversion based on coding methods of the texture data and the displacement data.

2. The method of claim 1, further comprising converting the displacement data to a 4:2:0 format, and concatenating the displacement data as converted with the texture data in the 4:2:0 format.

3. The method of claim 1, further comprising converting the displacement data to N-bit, wherein the N-bit is a bitdepth of the texture data, and where N is an integer.

4. The method of claim 3, wherein N is 10.

5. The method of claim 1, wherein the texture data and the displacement data are coded in different slices.

6. The method of claim 1, wherein one or both of a position and a size of the texture data are included in the single bitstream.

7. The method of claim 1, wherein one or both of a position and a size of the displacement data are included in the single bitstream.

8. The method of claim 1, wherein one or both of a position and a size of the texture data are inferred based on information in the single bitstream.

9. The method of claim 1, wherein one or both of a position and a size of the displacement data are inferred based on information in the single bitstream.

10. The method of claim 1, wherein the displacement data is coded in 4:2:0 format.

11. The method of claim 10, wherein the displacement data is converted to the 4:2:0 format prior to encoding the single video into the single bitstream, and converted to a 4:4:4 format after decoding the single video from the single bitstream.

12. The method of claim 10, wherein one or both of an sps_chroma_format_idc syntax element and a ChromaFormatIdc variable is set to 1 for coding the displacement data.

13. The method of claim 10, wherein coding of the displacement data uses a main profile.

14. The method of claim 10, wherein coding of the displacement data uses a main10 profile.

15. The method of claim 10, wherein the displacement data is packed into luma components and chroma components in the 4:2:0 format when the displacement data has only one non-zero component.

16. The method of claim 1, wherein the conversion includes encoding the visual media data into a bitstream.

17. The method of claim 1, wherein the conversion includes decoding the visual media data from a bitstream.

18. An apparatus for processing media data comprising:
a processor; and
a non-transitory memory with instructions thereon, wherein the instructions upon execution by the processor, cause the processor to:
code texture data and displacement data in a single bitstream or a single video during a conversion between the single video and the single bitstream; and
perform the conversion based on coding methods of the texture data and the displacement data.

19. A non-transitory computer readable medium, storing instructions that cause a processor to:
code texture data and displacement data in a single bitstream or a single video during a conversion between the single video and the single bitstream; and
perform the conversion based on coding methods of the texture data and the displacement data.

20. A non-transitory computer-readable recording medium storing a bitstream of a video which is generated by a method performed by a video processing apparatus, wherein the method comprises:
encoding texture data and displacement data in a single bitstream during generating the single bitstream from the video; and
generating the single bitstream based on coding methods of the texture data and the displacement data.
